(19) United States
(12) Patent Application Publication
(10) Pub. No.: US 2009/0139464 A1
(43) Pub. Date: Jun. 4, 2009

(54) Animal Restraint with Snap Hook and Buckle

(75) Inventors: Sarah Bell, Rose Hill, KS (US); Wayne Becker, (US)

Correspondence Address: SHOEMAKER AND MATTARE, LTD, 10 POST OFFICE ROAD - SUITE 100, SILVER SPRING, MD, 20910, US

(73) Assignee: ROSE AMERICA CORPORATION, Wichita, KS (US)

(21) Appl. No.: 11/950,023

(22) Filed: Dec. 4, 2007

(51) Int. Cl. A01K 1/06

(52) U.S. Cl. 119/778; 119/772; 119/779

(57) ABSTRACT

A animal restraint includes a buckle connected at one end to a leash or the like and its other end to a short tether having a D-ring termination. A snap hook with a latching side is easily connected to the restraint. The buckle has two relatively rotary parts which form a bayonet-type connection. The axis of rotation of the buckle parts is perpendicular to the tension axis, so that tension does not tend to undo the buckle.

### BACKGROUND OF THE INVENTION

This invention relates to a animal restraint which includes a snap hook and a buckle.

### SUMMARY OF THE INVENTION

An object of the invention is to provide an animal restraint which is versatile, simple to use, attractive and easy to manufacture.

These and other objects are attained by a animal restraint system as described below.

### BRIEF DESCRIPTION OF THE DRAWINGS

In the accompanying drawings,

FIG. 1 is a perspective view of an animal restraint embodying the invention, including a snap hook and a buckle;

FIG. 2 is a top plan view thereof, and

FIG. 3 is a side elevation thereof.

FIG. 4 is an exploded perspective view of the snap hook;

FIG. 5 is a top plan view thereof, with its latch open;

FIG. 6 is a side elevation thereof, with its latch closed; and

FIG. 7 is a top plan view thereof, with its latch closed.

FIG. 8 is a perspective view showing a female portion of the buckle from above;

FIG. 9 is a perspective view showing the female portion from below;

FIG. 10 is a perspective view showing a male portion of the buckle from above; and

FIG. 11 is a perspective view showing the male portion from below.

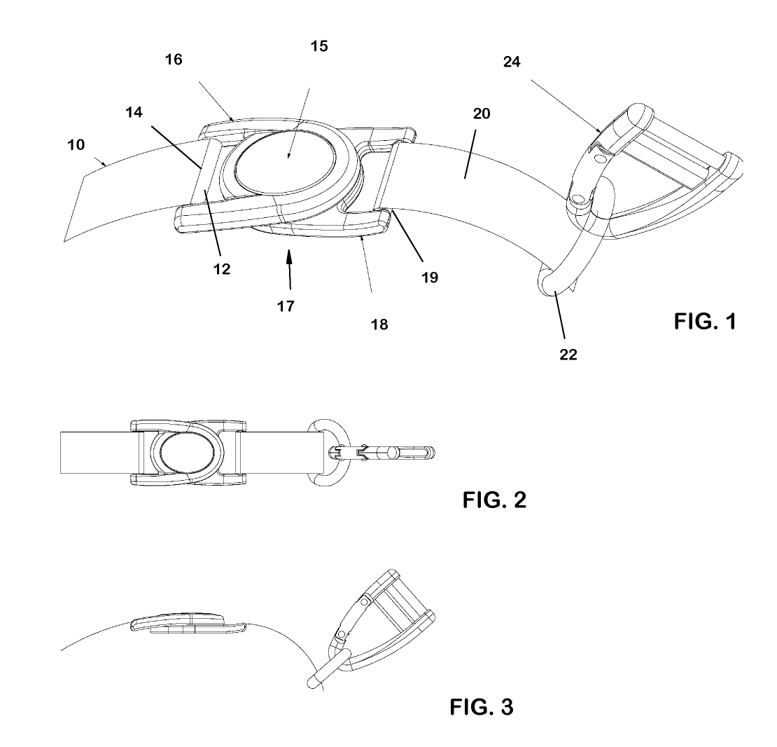

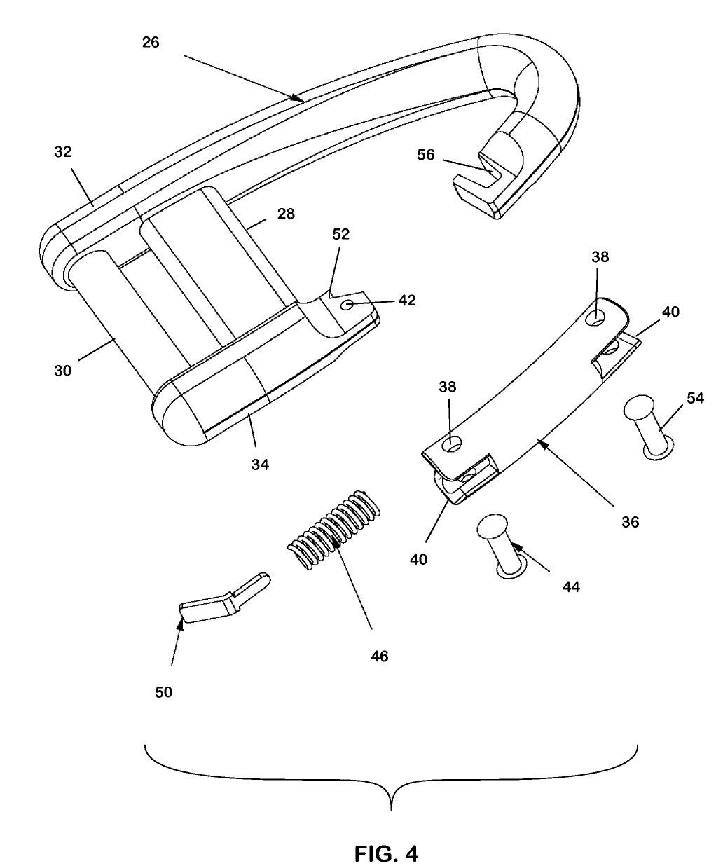

### DESCRIPTION OF THE PREFERRED EMBODIMENT

A animal restraint embodying the invention is shown in FIG. 1. It includes a retaining strap 10, for example a leash. Only one end of the strap is shown in the drawing. The illustrated strap end is looped at 12 around the anchor pin 14 of one part 16 of a two-part buckle 17. The other part 18 of the buckle has an anchor pin 19 around which a short tether 20 is looped. The other end of the tether is connected to a simple D-ring 22 into which a snap hook 24 may be inserted. Item 15 is a decorative trim disk.

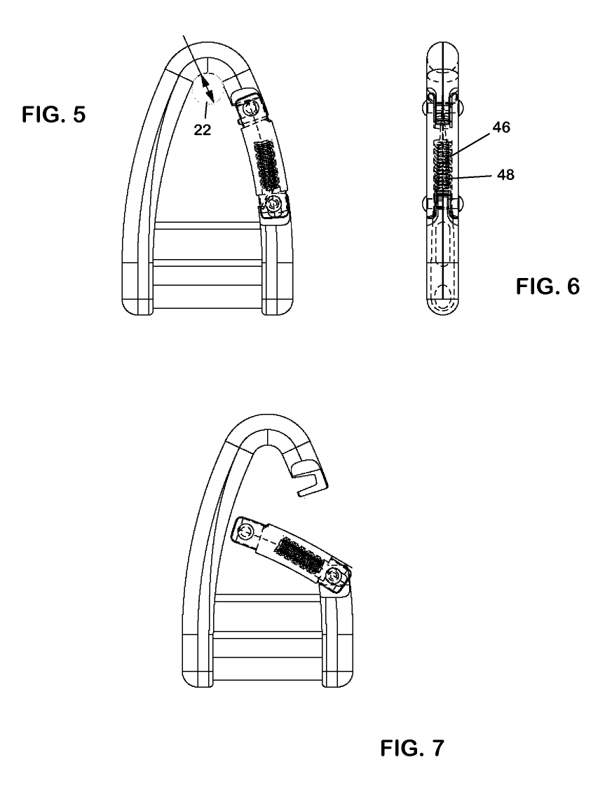

The snap hook 24, which is shown in detail in FIGS. 4-7, has an arch-shaped frame 26. Two parallel cross bars 28, 30 extend between the arms 32, 34 of the arch near its open end. Another strap (not shown) will normally be looped around at least one of the cross bars 28, 30. The cross bar 28 has substantial width, to rigidify the frame.

A pivoting gate 36 makes up a portion of the arch, when the gate is closed. Both ends of the gate are bifurcated and have holes 38 drilled through the tangs 40 at either end. At the end nearer the cross bars, the frame also has a through hole 42, and a hinge pin 44 is inserted through that hole and the holes at one end of the gate. The gate can pivot into the arch, opening the snap hook, when enough force is applied to overcome the bias provided by a coil spring 46 contained within a blind bore 48 (see FIG. 6) in the latch. The near end of the spring mounts over the tip of a spring support 50 (FIG. 4) disposed in a V-shaped seat 52 in the frame, near the hinge pin. Because the seat is offset to the inboard side of the hinge pin 44, the spring is compressed as the gate is opened. The distal end of the gate has a cross pin 54 which engages the bottom of a cutout 56 in the frame to stop the motion of the gate. The spring is still compressed somewhat at this position.

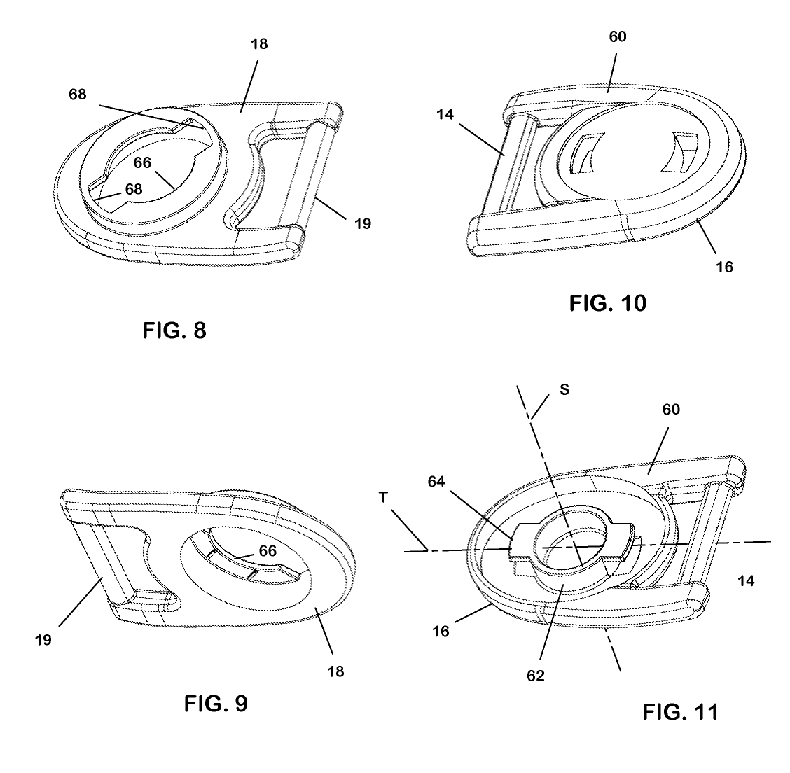

As shown in FIGS. 8-11, the buckle's bottom part 16 and a top part 18 having interlocking structures. In the preferred embodiment illustrated, the structures form a bayonet-type connection. The male (top) part of the connection has a base 60 supporting a central sleeve 62 which terminates at a pair of diametrically opposed lugs 64. The female (bottom) part 18 has a central hole 66 sized to receive the sleeve, and a pair of diametrically opposed cutouts 68 sized to receive the respective lugs when the parts are joined. The cutouts and lugs are arranged so that they are misaligned when the strap pins are 180° apart in their service position (see FIG. 1). The buckle can be undone by rotating one part with respect to the other about 90° about the axis “S” of the sleeve. The sleeve axis “S”, shown in FIG. 11, is perpendicular to the tension axis “T” which extends between the anchor posts. Therefore, tension in the strap does not tend to undo the buckle and in fact keeps the parts in their engaged position.

Materials and dimensions are not set out above, because these are matter of design choice depending on the intended use of the components. It is currently contemplated that the snap hook will be die-cast zinc and the buckle components will be injection molded from a strong plastic; however, other materials may be found useful or even superior in certain applications.

Since the invention is subject to modifications and variations, it is intended that the foregoing description and the accompanying drawings shall be interpreted as only illustrative of the invention defined by the following claims.

I claim:

1. An animal restraint comprising
a leash strap,
a tether strap having a termination,
a buckle having two interconnectable parts, one connected to the leash strap and the other connected to the tether strap, and
a snap hook which may be connected to the D-ring.

2. The invention of claim 1, wherein the two parts of the buckle have relatively rotatable interlocking structure comprising a pair of lugs on one part and a pair of complementary undercut slots in the other part, whereby the parts may be interconnected by aligning the lugs with the slots, then inserting the lugs into the slots and turning the parts to a position where the lugs and slots are not aligned.

3. The invention of claim 2, wherein the buckle parts are relatively rotatable about a rotation axis and have respective anchoring pins for the leash strap and tether strap respectively along a tension axis extending between the pins when the pins are opposed, wherein the rotation axis is perpendicular to the tension axis and the lugs and slots are misaligned when the pins are opposed so that the buckle can not come unfastened under load.

4. The invention of claim 1, wherein the snap hook comprises
a frame having a lateral opening therein,
a gate pivotally connected to the frame at one end of the opening, the gate closing the opening at a closed position of the gate, and being movable from said closed position, and
means for biasing the gate toward the closed position.

5. The invention of claim 4, wherein
the biasing means is a coil spring,
the gate is mounted on a hinge pin,
the gate has a blind hole in which the spring is situated, and
one end of the spring is mounted on a support which is offset to one side of the hinge pin so that the spring is compressed as the gate is opened.
